(19) United States
(12) Patent Application Publication
(10) Pub. No.: US 2019/0324961 A1
(43) Pub. Date: Oct. 24, 2019

(54) STORAGE METHOD AND QUERY METHOD FOR DATABASE, AND APPARATUS

(71) Applicant: Huawei Technologies Co., Ltd., Shenzhen (CN)

(72) Inventor: Dongwang SUN, Beijing (CN)

(21) Appl. No.: 16/455,744

(22) Filed: Jun. 28, 2019

Related U.S. Application Data
(63) Continuation of application No. PCT/CN2017/102499, filed on Sep. 20, 2017.

(30) Foreign Application Priority Data
Dec. 30, 2016 (CN) 201611262341.1

(51) Int. Cl. G06F 16/2453; G06F 16/22

(52) U.S. Cl. CPC G06F 16/2453; G06F 16/2228

(57) ABSTRACT

Embodiments of the present invention disclose a storage method and a query method for a database, and an apparatus, and relate to the field of computer technologies. A specific solution is: receiving a query request, where the query request is used to query data that is in a database and that meets a query condition; determining a data query range corresponding to the query condition, and determining a matched index item from multiple index items, where a value range indicated by an index key in the matched index item includes the data query range; and reading the data from a storage unit to which an index value in the matched index item points.

### CROSS-REFERENCE TO RELATED APPLICATIONS

This application is a continuation of International Application No. PCT/CN2017/102499, filed on Sep. 20, 2017, which claims priority to Chinese Patent Application No. 201611262341.1, filed on Dec. 30, 2016. The disclosures of the aforementioned applications are hereby incorporated by reference in their entireties.

### TECHNICAL FIELD

Embodiments of the present invention relate to the field of computer technologies, and in particular, to a storage method and a query method for a database, and an apparatus.

### BACKGROUND

A database may organize, store, and manage data on a computer device according to a data structure. The database may include multiple storage units configured to store data. To improve data query efficiency in the database, an index may be created for data stored in the database.

A data query process in the prior art may include: determining, according to an index, a storage unit that stores data in a database, and reading the data from the determined storage unit.

However, the determined storage unit may further store a relatively large amount of data (referred to as redundant data) in addition to the data. In the prior art, when the data is read from the determined storage unit, data stored in the storage unit needs to be read one by one to obtain the data, that is, in the prior art, when the data is read from the determined storage unit, the data needs to be read, and a relatively large amount of redundant data may also need to be read. Reading a relatively large amount of redundant data causes relatively high data query overheads, and affects data query efficiency.

### SUMMARY

This application provides a storage method and a query method for a database, and an apparatus, to reduce data query overheads, and improve data query efficiency.

To achieve the foregoing objective, the following technical solutions are used in embodiments of this application.

According to a first aspect, this application provides a query method for a database, where the database includes multiple storage units, an index of the database includes multiple index items, each index item includes an index key and at least one index value, each of the at least one index value points to one storage unit in the database, the index key is used to indicate a value range of data corresponding to the index item in first data, the first data is data stored in a storage unit to which the at least one index value points, and the query method for a database includes: receiving a query request, where the query request is used to query data that is in the database and that meets a query condition; determining a data query range corresponding to the query condition, and determining a matched index item from the multiple index items, where a value range indicated by an index key in the matched index item includes the data query range; and reading, according to the value range indicated by the index key in the matched index item, the data from a storage unit to which an index value in the matched index item points.

An index key in an index item is used to indicate a value range of data corresponding to the index item in first data (that is, data stored in a storage unit to which at least one index value points). Therefore, in this application, when the data is read, only data that is corresponding to the value range indicated by the index key in the matched index item and that is in data stored in the storage unit to which the index value in the matched index item points may be read, and there is no need to read, one by one, all the data stored in the storage unit indicated by matched the index item. In this way, a case in which a relatively large amount of redundant data (that is, data that is other than the data and that is stored in the storage unit to which the index value in the matched index item points) is read can be avoided, so that data query overheads can be reduced, and data query efficiency can be improved.

In an implementation of the first aspect, before the “reading the data from a storage unit to which an index value in the matched index item points”, the query method for a database may further include: if a difference between two boundary values of the value range indicated by the index key in the matched index item is greater than a first split threshold, splitting the matched index item into at least two index sub-items according to the two boundary values of the value range indicated by the index key in the matched index item and two boundary values of the data query range; and determining a matched index sub-item from the at least two index sub-items, where a value range indicated by an index key in the matched index sub-item includes the data query range. The “reading, according to the value range indicated by the index key in the matched index item, the data from a storage unit to which an index value in the matched index item points” may include: reading, according to the value range indicated by the index key in the matched index sub-item, the data from a storage unit to which an index value in the matched index sub-item points.

The value range indicated by the index key in the matched index item includes the data query range, that is, the value range indicated by the index key in the matched index item is greater than or equal to the data query range, and the at least two index sub-items are obtained after the matched index item is split according to the two boundary values of the value range indicated by the index key in the matched index item and the two boundary values of the data query range. Therefore, a value range indicated by an index key in one (that is, the matched index sub-item) of the at least two index sub-items may include the data query range, that is, the value range indicated by the index key in the matched index sub-item is greater than or equal to the data query range. In addition, a larger difference between two boundary values of a value range indicated by an index key in an index item indicates a larger amount of data corresponding to the index item. In this case, after the matched index item is split into at least two index sub-items, an amount of data corresponding to any one (such as the matched index sub-item) of the at least two index sub-items is less than an amount of data corresponding to the matched index item.

In conclusion, both the value range indicated by the index key in the matched index sub-item and the value range indicated by the index key in the matched index item include the data query range, and the amount of data corresponding to the matched index sub-item is less than the amount of data corresponding to the matched index item. Therefore, it can be learned that an amount of redundant data (that is, data that is other than the data, that is corresponding to the matched index sub-item, and that is stored in storage units to which all index values in the matched index sub-item point) stored in the storage units to which all the index values in the matched index sub-item point is less than an amount of redundant data (that is, data that is other than the data, that is corresponding to the matched index item, and that is stored in storage units to which all index values in the matched index item point) stored in the storage units to which all the index values in the matched index item point. In the query method for a database provided in this embodiment of the present invention, the data is read from data that is corresponding to the matched index sub-item and that is stored in the storage units to which all the index values in the matched index sub-item point, so that an amount of redundant data that needs to be read can be further reduced, data query overheads can be further reduced, and data query efficiency can be further improved.

In an implementation of the first aspect, after the splitting the matched index item into at least two index sub-items, the method in this embodiment of the present invention may further include: updating the stored matched index item to the at least two index sub-items.

A larger difference between two boundary values of a value range indicated by an index key in an index item indicates a larger amount of data corresponding to the index item. In this case, after the matched index item is split into at least two index sub-items, an amount of data corresponding to any one of the at least two index sub-items is less than the amount of data corresponding to the matched index item.

In an implementation of the first aspect, the first split threshold may be first calculated before it is determined whether the difference between the two boundary values of the value range indicated by the index key in the matched index item is greater than the first split threshold. A method for calculating the first split threshold in this embodiment of the present invention may include: determining a current global value range, where the current global value range includes value ranges indicated by index keys in all stored index items; and calculating a ratio of a difference between two boundary values of the current global value range to m, to obtain the first split threshold, where m is a total quantity of storage units to which all the index values in the matched index item point.

The value ranges indicated by the index keys in all the stored index items include the value range indicated by the index key in the matched index item. The first split threshold is the ratio of the difference between the two boundary values of the current global value range to m (the total quantity of storage units to which all the index values in the matched index item point), that is, the first split threshold is a difference between two boundary values of any one of m value ranges obtained after the current global value range is evenly divided by using the total quantity of storage units to which all the index values in the matched index item point.

According to a second aspect, this application provides a storage method for a database, where the database includes multiple storage units, and the storage method for a database includes: receiving a storage request, and storage, in at least one first storage unit in the database, to-be-stored data carried in the storage request; generating a first index item, where the first index item includes a first index key and at least one first index value, the at least one first index value points to the at least one first storage unit, and the first index key is used to indicate a value range of the to-be-stored data in data stored in the at least one first storage unit; and storing the first index item in an index of the database.

In the storage method for a database, the to-be-stored data can be stored in the database, and an index item (that is, the first index item) can further be generated and stored for the to-be-stored data. The first index item includes the first index key and the at least one first index value, and the first index key is used to indicate the value range of the to-be-stored data in the data stored in the at least one first storage unit. Therefore, when the to-be-stored data that is stored in the database is queried, only data that is corresponding to the value range indicated by the index key in the first index item and that is in the data stored in the storage unit (that is, the at least one first storage unit) to which the index value in the first index item points may be read, and there is no need to read, one by one, all the data stored in the at least one first storage unit. In this way, a case in which a relatively large amount of redundant data (that is, data that is other than the to-be-stored data and that is stored in the storage unit to which the index value in the first index item points) is read can be avoided, so that data query overheads can be reduced, and data query efficiency can be improved.

In an implementation of the second aspect, before the “storing the first index item in an index of the database”, the storage method for a database may further include: determining a second index item from the index of the database, where an intersection set exists between a value range indicated by an index key in the second index item and the value range indicated by the index key in the first index item; and if a difference between two boundary values of the value range indicated by the index key in the first index item is greater than a second split threshold, or a difference between two boundary values of the value range indicated by the index key in the second index item is greater than a second split threshold, splitting the first index item and/or the second index item according to the two boundary values of the value range indicated by the index key in the first index item and the two boundary values of the value range indicated by the index key in the second index item, to obtain at least two first index sub-items. The “storing the first index item in an index of the database” may include: updating the stored second index item to the at least two first index sub-items.

When an intersection set exists between the value range indicated by the index key in the to-be-stored first index item and the value range indicated by the index key in the stored second index item, if both the first index item and the second index item are stored, there is a problem of storing two index items for same data. In this embodiment of the present invention, the first index item and/or the second index item may be split, to obtain at least two first index sub-items. The at least two first index sub-items are obtained after the first index item and the second index item are split or after the first index item is split or after the first index item is split. Therefore, data that is corresponding to the at least two first index sub-items and that is stored in storage units to which all index values in the at least two first index sub-items point includes all data that is corresponding to the first index item and the second index item and that is stored in all storage units to which all index values in the first index item and the second index item point. Therefore, the stored second index item is updated to the at least two first index sub-items, so that all data corresponding to the first index item and the second index item can be stored, and the problem of storing two index items for same data can also be resolved.

In addition, if the difference between the two boundary values of the value range indicated by the index key in the first index item is greater than the second split threshold, or the difference between the two boundary values of the value range indicated by the index key in the second index item is greater than the second split threshold, it indicates that the first index item or the second index item is corresponding to a relatively large amount of data. In this embodiment of the present invention, after the first index item and/or the second index item are/is split into at least two first index sub-items, an amount of data corresponding to each of the at least two first index sub-items is less than an amount of all data corresponding to the first index item and/or the second index item. Therefore, an amount of data that needs to be read when data is read from data that is stored in storage units to which all index values in any one of the at least two first index sub-items point and that is corresponding to the any one first index sub-item is less than an amount of data that needs to be read when the data is read from all the data that is corresponding to the first index item and/or the second index item and that is stored in the storage units to which all the index values in the first index item and/or the second index item point. That is, in this solution, an amount of data that needs to be read can be reduced, so that data query overheads can be reduced, and data query efficiency can be improved.

In an implementation of the second aspect, the second split threshold may be first calculated before it is determined whether the difference between the two boundary values of the value range indicated by the index key in the first index item is greater than the second split threshold, or whether the difference between the two boundary values of the value range indicated by the index key in the second index item is greater than the second split threshold.

A method for calculating the second split threshold in this application may include: determining a current global value range, where the current global value range includes value ranges indicated by index keys in all stored index items; and calculating a ratio of a difference between two boundary values of the current global value range to q, to obtain the second split threshold, where q is a total quantity of storage units to which all index values in the first index item point.

The value ranges indicated by the index keys in all the stored index items include the value range indicated by the index key in the first index item and the value range indicated by the index key in the second index item. The second split threshold is the ratio of the difference between the two boundary values of the current global value range to q (the total quantity of storage units to which all the index values in the first index item point), that is, the second split threshold is a difference between two boundary values of any one of q value ranges obtained after the current global value range is evenly divided by using the total quantity of storage units to which all the index values in the first index item point.

In an implementation of the second aspect, the storage method for a database may further include: combining the first index item and the second index item if the difference between the two boundary values of the value range indicated by the index key in the first index item is less than or equal to the second split threshold, and the difference between the two boundary values of the value range indicated by the index key in the second index item is less than or equal to the second split threshold. The “storing the first index item in an index of the database” may include: updating the stored second index item to an index item obtained after the combination.

When the difference between the two boundary values of the value range indicated by the index key in the first index item is less than or equal to the second split threshold, and the difference between the two boundary values of the value range indicated by the index key in the second index item is less than or equal to the second split threshold, it indicates that the first index item and the second index item is corresponding to a relatively small amount of data. When an intersection set exists between the value range indicated by the index key in the to-be-stored first index item and the value range indicated by the index key in the stored second index item, and the first index item and the second index item are each corresponding to a relatively small amount of data, it may be determined that the first index item and the second index item are substantially corresponding to same data. In this case, if the first index item is directly stored, because both the first index item and the second index item are stored, there is a problem of storing two index items for same data. In the foregoing solution, the first index item and the second index item whose value ranges have an intersection set may be combined, and the stored second index item may be updated to the index item obtained after the combination. In this way, the problem of storing two index items for same data can be resolved.

In an implementation of the second aspect, before the “storing the first index item in an index of the database”, the storage method for a database may further include: splitting the first index item into k index sub-items if a difference between two boundary values of the value range indicated by the index key in the first index item is greater than a third split threshold. The “storing the first index item in an index of the database” may include: storing the k index sub-items, where 2≤k≤n, and n is a total quantity of storage units to which all index values in the first index item point.

When the difference between the two boundary values of the value range indicated by the index key in the first index item is greater than the third split threshold, it indicates that the first index item is corresponding to a relatively large amount of data. In this solution, the first index item may be split to obtain k index sub-items. Because the k index sub-items are obtained after the first index item is split, data that is corresponding to the k index sub-items and that is stored in storage units to which all index values in the k index sub-items point includes data that is corresponding to the first index item and that is stored in the storage units to which all the index values in the first index item point. In this way, after the k index sub-items are stored, all the data corresponding to the first index item may be stored. In addition, an amount of data corresponding to each of the k index sub-items is less than an amount of data corresponding to the first index item. Therefore, an amount of data that needs to be read when data is read from data that is corresponding to any one of the k index sub-items and that is stored in storage units to which all index values in the any one of the k index sub-items point is less than an amount of data that needs to be read when the data is read from the data that is corresponding to the first index item and that is stored in the storage units to which all the index values in the first index item point. That is, in this solution, an amount of data that needs to be read during data query can be reduced, so that data query overheads are reduced, and data query efficiency is improved.

In an implementation of the second aspect, the third split threshold may be first calculated before it is determined whether the difference between the two boundary values of the value range indicated by the index key in the first index item is greater than the third split threshold. A method for calculating the third split threshold in this application may include: determining a current global value range, where the current global value range includes value ranges indicated by index keys in all stored index items; and calculating a ratio of a difference between two boundary values of the current global value range to n, to obtain the third split threshold.

The value ranges indicated by the index keys in all the stored index items include the value range indicated by the index key in the first index item. The third split threshold is the ratio of the difference between the two boundary values of the current global value range to n (the total quantity of storage units to which all the index values in the first index item point), that is, the third split threshold is a difference between two boundary values of any one of n value ranges obtained after the current global value range is evenly divided by using n.

According to a third aspect, this application provides a management apparatus for a database, where the database includes multiple storage units, an index of the database includes multiple index items, each index item includes an index key and at least one index value, each of the at least one index value points to one storage unit in the database, and the index key is used to indicate a value range of data corresponding to the index item in first data (that is, data stored in a storage unit to which the at least one index value points). The management apparatus for a database includes a receiving module, a determining module, and a reading module. The receiving module is configured to receive a query request, where the query request is used to query data that is in the database and that meets a query condition. The determining module is configured to: determine a data query range corresponding to the query condition in the query request received by the receiving module, and determine a matched index item from the multiple index items, where a value range indicated by an index key in the matched index item includes the data query range. The reading module is configured to read, according to the value range indicated by the index key in the matched index item determined by the determining module, the data from a storage unit to which an index value in the matched index item points.

In an implementation of the third aspect, the management apparatus for a database may further include a splitting module. The splitting module is configured to: before the reading module reads the data from the storage unit to which the index value in the matched index item points, if a difference between two boundary values of the value range indicated by the index key in the matched index item determined by the determining module is greater than a first split threshold, split the matched index item into at least two index sub-items according to the two boundary values of the value range indicated by the index key in the matched index item and two boundary values of the data query range. The determining module may be further configured to determine a matched index sub-item from the at least two index sub-items obtained by the splitting module after the splitting, where a value range indicated by an index key in the matched index sub-item includes the data query range. The determining module may be specifically configured to read, according to the value range indicated by the index key in the matched index sub-item, the data from a storage unit to which an index value in the matched index sub-item determined by the determining module points.

In an implementation of the third aspect, the management apparatus for a database may further include a storage module. The storage module is configured to: after the splitting module splits the matched index item into at least two index sub-items, update the stored matched index item to the at least two index sub-items.

In an implementation of the third aspect, the management apparatus for a database may further include a calculation module. The determining module may be further configured to determine a current global value range before the splitting module determines whether the difference between the two boundary values of the value range indicated by the index key in the matched index item is greater than the first split threshold, where the current global value range includes value ranges indicated by index keys in all stored index items. The calculation module is configured to obtain the first split threshold according to a ratio of a difference between two boundary values of the current global value range determined by the determining module to m, where m is a total quantity of storage units to which all index values in the matched index item point.

It should be noted that function units in the third aspect and the possible implementations of the third aspect in this embodiment of the present invention are obtained after the management apparatus for a database is logically divided, to execute the query method for a database in the first aspect and the optional manners of the first aspect. For detailed descriptions and beneficial effect analyses of the function units in the third aspect and the possible implementations of the third aspect, refer to the corresponding descriptions and technical effects in the first aspect and the possible implementations of the first aspect. Details are not described herein.

According to a fourth aspect, this application provides a management apparatus for a database, where the management apparatus for a database includes a processor, a memory, and a communications interface. The memory is configured to store a computer execution instruction. The processor, the communications interface, and the memory are connected by using a bus. When the management apparatus for a database runs, the processor executes the computer execution instruction stored in the memory, so that the management apparatus for a database executes the query method for a database according to the first aspect and the optional manners of the first aspect.

According to a fifth aspect, a computer storage medium is provided, where the computer storage medium stores code; and when the processor in the management apparatus for a database in the fourth aspect executes the program codes, the management apparatus for a database executes the query method for a database according to the first aspect and the optional manners of the first aspect.

For detailed descriptions and corresponding technical effect analyses of the modules in the management apparatuses for a database in the third aspect and the fourth aspect, refer to the detailed descriptions in the first aspect and the possible implementations of the first aspect. Details are not described in this embodiment of the present invention.

According to a sixth aspect, this application provides a management apparatus for a database, where the database includes multiple storage units, and the management apparatus for a database includes a receiving module, a first saving module, a generation module, and a second saving module. The receiving module is configured to receive a storage request. The first saving module is configured to store, in at least one first storage unit in the database, to-be-stored data carried in the storage request received by the receiving module. The generation module is configured to generate a first index item, where the first index item includes a first index key and at least one first index value, the at least one first index value points to the at least one first storage unit, and the first index key is used to indicate a value range of the to-be-stored data in data stored in the at least one first storage unit. The second saving module is configured to store, in an index of the database, the first index item generated by the generation module.

In an implementation of the sixth aspect, the management apparatus for a database may further include a determining module and a splitting module. The determining module is configured to: before the second saving module stores the first index item, determine a second index item from the index of the database, where an intersection set exists between a value range indicated by an index key in the second index item and the value range indicated by the index key in the first index item. The splitting module is configured to: if a difference between two boundary values of the value range indicated by the index key in the first index item generated by the generation module is greater than a second split threshold, or a difference between two boundary values of the value range indicated by the index key in the second index item determined by the determining module is greater than a second split threshold, split the first index item and/or the second index item according to the two boundary values of the value range indicated by the index key in the first index item and the two boundary values of the value range indicated by the index key in the second index item, to obtain at least two first index sub-items. The second saving module may be specifically configured to update the stored second index item to the at least two first index sub-items.

In an implementation of the sixth aspect, the management apparatus for a database may further include a calculation module. The determining module may be further configured to determine a current global value range before the splitting module determines whether the difference between the two boundary values of the value range indicated by the index key in the first index item is greater than the second split threshold, or whether the difference between the two boundary values of the value range indicated by the index key in the second index item is greater than the second split threshold, where the current global value range includes value ranges indicated by index keys in all stored index items. The calculation module is configured to calculate a ratio of a difference between two boundary values of the current global value range to q, to obtain the second split threshold, where q is a total quantity of storage units to which all index values in the first index item point.

In an implementation of the sixth aspect, the management apparatus for a database may further include a combination module. The combination module is configured to combine the first index item and the second index item if the difference between the two boundary values of the value range indicated by the index key in the first index item generated by the generation module is less than or equal to the second split threshold, and the difference between the two boundary values of the value range indicated by the index key in the second index item determined by the determining module is less than or equal to the second split threshold. The second saving module may be specifically configured to update the stored second index item to an index item obtained by the combination module after the combination.

In an implementation of the sixth aspect, the management apparatus for a database may further include a splitting module. The splitting module is configured to: before the second saving module stores the first index item, split the first index item into k index sub-items if a difference between two boundary values of the value range indicated by the index key in the first index item generated by the generation module is greater than a third split threshold. The second saving module may be specifically configured to store the k index sub-items, where 2≤k≤n, and n is a total quantity of storage units to which all index values in the first index item point.

In an implementation of the sixth aspect, the management apparatus for a database may further include a calculation module. The determining module may be further configured to determine a current global value range before the splitting module determines whether the difference between the two boundary values of the value range indicated by the index key in the first index item is greater than the third split threshold, where the current global value range includes value ranges indicated by index keys in all stored index items. The calculation module is configured to calculate a ratio of a difference between two boundary values of the current global value range to n, to obtain the third split threshold.

It should be noted that function units in the sixth aspect and the possible implementations of the sixth aspect in this embodiment of the present invention are obtained after the management apparatus for a database is logically divided, to execute the storage method for a database in the second aspect and the optional manners of the second aspect. For detailed descriptions and beneficial effect analyses of the function units in the sixth aspect and the possible implementations of the sixth aspect, refer to the corresponding descriptions and technical effects in the second aspect and the possible implementations of the second aspect. Details are not described herein.

According to a seventh aspect, this application provides a management apparatus for a database, where the management apparatus for a database includes a processor, a memory, and a communications interface. The memory is configured to store a computer execution instruction. The processor, the communications interface, and the memory are connected by using a bus. When the management apparatus for a database runs, the processor executes the computer execution instruction stored in the memory, so that the management apparatus for a database executes the storage method for a database according to the second aspect and the optional manners of the second aspect.

According to an eighth aspect, a computer storage medium is provided, where the computer storage medium stores code; and when the processor in the management apparatus for a database in the seventh aspect executes the program codes, the management apparatus for a database executes the storage method for a database according to the second aspect and the optional manners of the second aspect.

For detailed descriptions and corresponding technical effect analyses of the modules in the management apparatuses for a database in the sixth aspect and the seventh aspect, refer to the detailed descriptions in the second aspect and the possible implementations of the second aspect. Details are not described in this embodiment of the present invention.

### BRIEF DESCRIPTION OF DRAWINGS

FIG. 1 is a schematic structural diagram of a management apparatus for a database according to an embodiment of the present invention;

FIG. 2 is a flowchart of a storage method for a database according to an embodiment of the present invention;

FIG. 3 is a flowchart of another storage method for a database according to an embodiment of the present invention;

FIG. 4A and FIG. 4B are flowcharts of another storage method for a database according to an embodiment of the present invention;

FIG. 5A and FIG. 5B are schematic diagrams of an example in which a management apparatus for a database splits an index item according to an embodiment of the present invention;

FIG. 6 is a flowchart of a query method for a database according to an embodiment of the present invention;

FIG. 7 is a flowchart of another query method for a database according to an embodiment of the present invention;

FIG. 8 is a schematic diagram of another example in which a management apparatus for a database splits an index item according to an embodiment of the present invention;

FIG. 9 is a flowchart of another query method for a database according to an embodiment of the present invention;

FIG. 10 is a schematic structural diagram of another management apparatus for a database according to an embodiment of the present invention;

FIG. 11 is a schematic structural diagram of another management apparatus for a database according to an embodiment of the present invention;

FIG. 12 is a schematic structural diagram of another management apparatus for a database according to an embodiment of the present invention;

FIG. 13 is a schematic structural diagram of another management apparatus for a database according to an embodiment of the present invention;

FIG. 14 is a schematic structural diagram of another management apparatus for a database according to an embodiment of the present invention;

FIG. 15 is a schematic structural diagram of another management apparatus for a database according to an embodiment of the present invention; and

FIG. 16 is a schematic structural diagram of another management apparatus for a database according to an embodiment of the present invention.

### DESCRIPTION OF EMBODIMENTS

A storage method and a query method for a database, and an apparatus that are provided in embodiments of the present invention may be applied to a data storage process and a data query process in the database, and are specifically applied to a process of storing and querying data according to an index item in an index.

The database in the embodiments of the present invention includes multiple storage units, and the multiple storage units are configured to store data. The index of the database may include multiple index items. Each index item includes an index key and at least one index value. Each of the at least one index value points to one storage unit in the database. The index key is used to indicate a value range of data corresponding to the index item in first data. The first data is data stored in a storage unit to which the at least one index value points.

As shown in Table 1, Table 1 shows, in a form of a table, an example of the index provided in the embodiments of the present invention. An index corresponding to an index table shown in Table 1 may include n index items, each index item includes an index key (English: Key) and at least one index value (English: Value), and n≥2.

TABLE 1
Index table

| | | |
|---|---|---|
| Index item 1 | Index key 1 | Index value 1-1 |
| | [min 1, max 1] | (storage unit a) |
| | | Index value 1-2 |
| | | (storage unit b) |
| | | Index value 1-3 |
| | | (storage unit c) |
| Index item 2 | Index key 2 | Index value 2-1 |
| | [min 2, max 2] | Index value 2-2 |
| . . . | . . . | . . . |
| Index item n | Index key n | Index value n − 1 |
| | [min n, max n] | Index value n − 2 |
| | | . . . |
| | | Index value n-k |

The index item 1 shown in Table 1 is used as an example. The index item 1 may include three index values (the index value 1-1, the index value 1-2, and the index value 1-3). The index value 1-1 points to the storage unit a, the index value 1-2 points to the storage unit b, and the index value 1-3 points to the storage unit c.

The index key in the index item 1 shown in Table 1 may be used to indicate a value range [min 1, max 1] of data corresponding to the index item 1 in first data. In this case, the first data may be data stored in the storage unit a to which the index value 1-1 points, data stored in the storage unit b to which the index value 1-2 points, and data stored in the storage unit c to which the index value 1-3 points. That is, data that needs to be read when data query is performed according to the index item 1 may include data whose value range is [min 1, max 1] and that is stored in the storage unit a to which the index value 1-1 shown in Table 1 points, data whose value range is [min 1, max 1] and that is stored in the storage unit b to which the index value 1-2 shown in Table 1 points, and data whose value range is [min 1, max 1] and that is stored in the storage unit c to which the index value 1-3 shown in Table 1 points.

For example, the index value may be a pointer that points to a storage unit, or the index value may be an address of a storage unit.

The storage method and the query method for a database that are provided in the embodiments of the present invention may be applied to a computer of a von Neumann architecture. The storage method and the query method for a database that are provided in the embodiments of the present invention may be executed by a management apparatus for a database. The management apparatus for a database may be the computer of the von Neumann architecture. The computer may be a terminal device or a server that can be configured to store or query data in the database, or the computer may be the management apparatus for a database. This is not limited in the embodiments of the present invention.

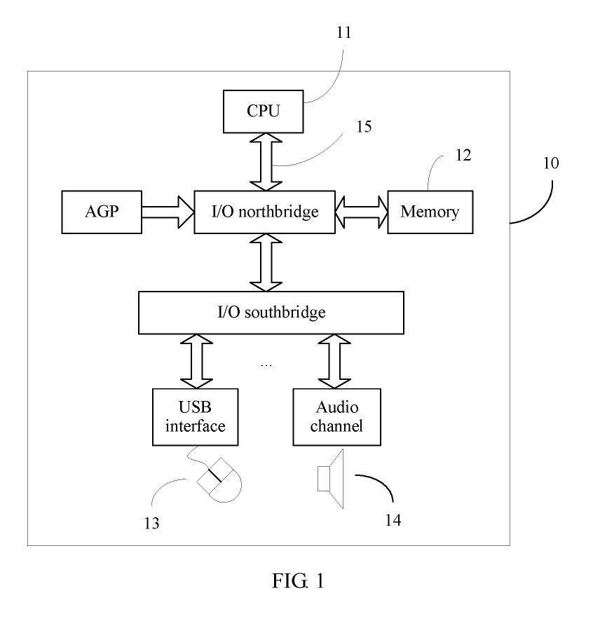

FIG. 1 is a schematic structural diagram of a management apparatus for a database according to an embodiment of the present invention. The management apparatus for a database provided in this embodiment of the present invention may be configured to implement the methods implemented in the embodiments of the present invention. For ease of description, only a part related to this embodiment of the present invention is shown. For specific technical details that are not disclosed, refer to the embodiments of the present invention. An example in which the management apparatus for a database is a personal computer (PC) is used in this embodiment of the present invention for description. FIG. 1 is a block diagram of a partial structure of a PC 10 related to the embodiments of the present invention.

As shown in FIG. 1, the PC 10 may include a Central Processing Unit (CPU) 11, a memory 12, an input device 13, an output device 14, a bus 15, and the like.

The memory 12 may be configured to store computer program code, running data, and/or a module. For example, the memory 12 may be configured to store computer program code corresponding to a query method or a storage method for a database provided in the embodiments of the present invention. The memory 12 may be further configured to store an index in the embodiments of the present invention. The database in the embodiments of the present invention may be stored in the memory 12, or the database may be stored in a storage device other than the memory 12.

The CPU 11 is a control center of the computer. The CPU 11 may run or execute the computer program code and/or modules stored in the memory 12, and invoke the data stored in the memory 12, to implement various function applications of the computer and perform data processing. For example, the CPU 11 may run the computer program code stored in the memory 12, to: execute the query method for a database provided in the embodiments of the present invention, to query data in the database; or execute the storage method for a database provided in the embodiments of the present invention, to store to-be-stored data in the database.

The CPU 11 runs on a motherboard chipset of a computer motherboard. For example, as shown in FIG. 1, the CPU 11 may run on an Input/Output (I/O) northbridge and an I/O southbridge of the computer motherboard. The I/O northbridge may be directly connected to the CPU 11 by using the bus 15, and is configured to control data communication with the CPU 11, an accelerate graphical port (AGP), and the memory 12. The I/O southbridge may be connected to the I/O northbridge by using the bus 15, and is configured to control an I/O part of the computer motherboard, such as an I/O interface and a Universal Serial Bus (USB).

The input device 13 may be configured to receive entered information, such as a data query request that carries query information in the embodiments of the present invention. For example, the input device 13 may be a keyboard, a mouse, or the like.

The output device 14 may be configured to output a running result of the CPU 11, such as the data in the embodiments of the present invention. For example, the output device 14 may be a monitor, an audio channel, or the like.

According to the storage method and the query method for a database, and the apparatus that are provided in the embodiments of the present invention, an amount of redundant data that needs to be read can be reduced, so that data query overheads can be reduced, and data query efficiency can be improved.

The storage method and the query method for a database, and the apparatus that are provided in the embodiments of the present invention are described in detail in the following with reference to the accompanying drawings by using specific embodiments and application scenarios of the specific embodiments.

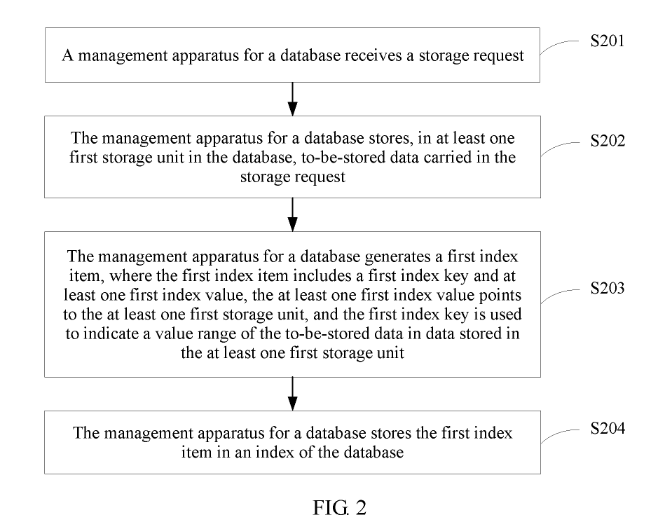

An embodiment of the present invention provides a storage method for a database. As shown in FIG. 2, the storage method for a database includes the following steps.

S201. A management apparatus for a database receives a storage request.

S202. The management apparatus for a database stores, in at least one first storage unit in the database, to-be-stored data carried in the storage request.

The storage request may carry the to-be-stored data and a destination storage address of the to-be-stored data. The management apparatus for a database may store the to-be-stored data in the at least one first storage unit in the database according to the destination storage address of the to-be-stored data. The destination storage address of the to-be-stored data is an address of the at least one first storage unit in the database.

S203. The management apparatus for a database generates a first index item, where the first index item includes a first index key and at least one first index value, the at least one first index value points to the at least one first storage unit, and the first index key is used to indicate a value range of the to-be-stored data in data stored in the at least one first storage unit.

The management apparatus for a database may generate an index item (that is, the first index item) for the to-be-stored data, and the first index item includes the first index key and the at least one first index value. In this way, when querying the to-be-stored data, the management apparatus for a database may query the to-be-stored data according to the first index item.

For example, the first index item may be specifically {[min 1, max 1], {s4}}, the value range indicated by the first index key included in the first index item is [min 1, max 1], and one first index value included in the first index item is s4.

S204. The management apparatus for a database stores the first index item in an index of the database.

The first index item may be used to query the to-be-stored data that is stored in the database.

In the storage method for a database provided in this embodiment of the present invention, the to-be-stored data can be stored in the database, and an index item (that is, the first index item) can further be generated and stored for the to-be-stored data. The index key in the first index item may be used to indicate the value range of the to-be-stored data in the data stored in the at least one first storage unit. Therefore, when the to-be-stored data that is stored in the database is queried, only data that is corresponding to the value range indicated by the index key in the first index item and that is in the data stored in the storage unit (that is, the at least one first storage unit) to which the index value in the first index item points may be read, and there is no need to read, one by one, all the data stored in the at least one first storage unit. In this way, a case in which a relatively large amount of redundant data (that is, data that is other than the to-be-stored data and that is stored in the storage unit to which the index value in the first index item points) is read can be avoided, so that data query overheads can be reduced, and data query efficiency can be improved.

Further, a larger difference between two boundary values of a value range indicated by an index key in an index item (such as the first index item) indicates a larger amount of data corresponding to the index item. If the first index item is corresponding to an excessively large amount of data, an amount of redundant data that needs be read when data query is performed according to the first index item may correspondingly increase. Reading a relatively large amount of redundant data causes relatively high data query overheads, and affects data query efficiency.

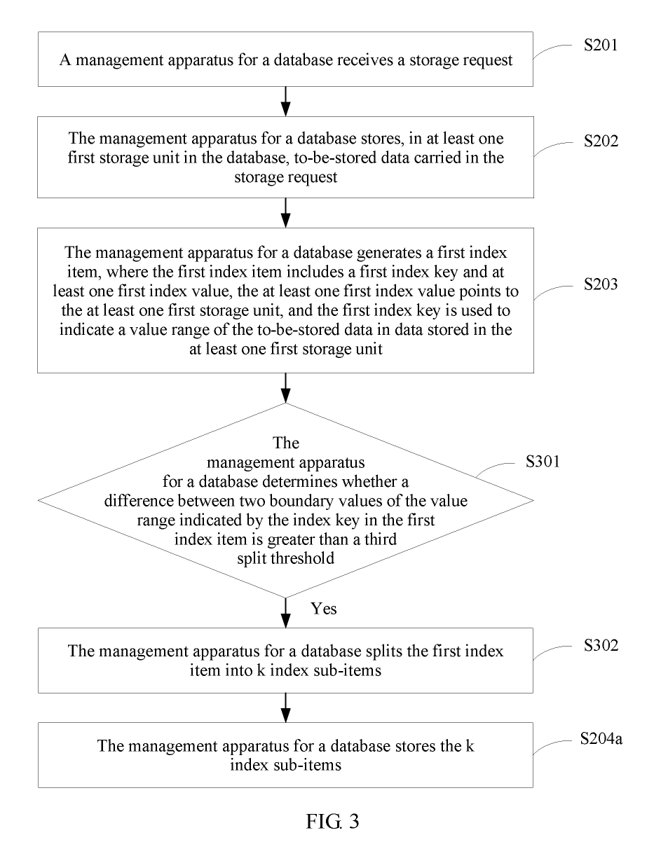

To resolve the foregoing problem, before storing the first index item in the index of the database, if determining that a difference between two boundary values of the value range indicated by the index key in the first index item is greater than a split threshold, the management apparatus for a database may split the first index item. As shown in FIG. 3, before S204 shown in FIG. 2, the storage method for a database provided in this embodiment of the present invention may further include S301.

S301. The management apparatus for a database determines whether a difference between two boundary values of the value range indicated by the index key in the first index item is greater than a third split threshold.

In a first implementation of this embodiment of the present invention, the third split threshold may be a preset threshold.

In a second implementation of this embodiment of the present invention, the management apparatus for a database may calculate a ratio of a difference between two boundary values of a current global value range to n, to obtain the third split threshold, where n is a total quantity of storage units to which all index values in the first index item point in the database.

That is, in the second implementation, the third split threshold may be a difference between two boundary values of any one of n value ranges obtained after the current global value range is evenly divided.

The current global value range includes value ranges indicated by index keys in all stored index items, and the value ranges indicated by the index keys in all the stored index items include the value range indicated by the index key in the first index item.

For example, if the value range indicated by the index key in the first index item {[min 1, max 1], {s4}} is {[min 1, max 1], and the current global value range may be represented as [min X, max X], min X≤min 1, and max X≥max 1. In addition, the two boundary values of the value range indicated by the index key in the first index item are min 1 and max 1, and the two boundary values of the current global value range are min X and max X. In this case, the third split threshold is (max X−min X)/n. Provided that the difference between min 1 and max 1 is greater than (max X−min X)/n, the management apparatus for a database may split the first index item into k (2≤k≤n) index sub-items.

Specifically, if the difference between the two boundary values of the value range indicated by the index key in the first index item is greater than the third split threshold, it indicates that the first index item is corresponding to a relatively large amount of data, and the management apparatus for a database may continue to perform S302. If the difference between the two boundary values of the value range indicated by the index key in the first index item is less than or equal to the third split threshold, it indicates that the first index item is corresponding to a relatively small amount of data, and the management apparatus for a database may continue to perform S204.

S302. The management apparatus for a database splits the first index item into k index sub-items.

In the foregoing step, 2≤k≤n, and n is the total quantity of storage units to which all the index values in the first index item point.

Correspondingly, as shown in FIG. 3, S204 in FIG. 2 may be replaced with S204a.

S204a. The management apparatus for a database stores the k index sub-items.

Because the k index sub-items are obtained after the management apparatus for a database splits the first index item, data that is corresponding to the k index sub-items and that is stored in storage units to which all index values in the k index sub-items point includes data that is corresponding to the first index item and that is stored in the storage units to which all the index values in the first index item point. In this way, after storing the k index sub-items, the management apparatus for a database may store all the data corresponding to the first index item.

In addition, after the management apparatus for a database splits the first index item into k index sub-items, an amount of data corresponding to each of the k index sub-items is less than an amount of data corresponding to the first index item. Therefore, an amount of data that needs to be read by the management apparatus for a database when reading the to-be-stored data from data that is corresponding to any one of the k index sub-items and that is stored in storage units to which all index values in the any one of the k index sub-items point is less than an amount of data that needs to be read by the management apparatus for a database when reading the to-be-stored data from the data that is corresponding to the first index item and that is stored in the storage units to which all the index values in the first index item point. That is, in this solution, an amount of data that needs to be read during data query can be reduced, so that data query overheads are reduced, and data query efficiency is improved.

Further, when an intersection set exists between the value range indicated by the index key in the to-be-stored first index item and a value range indicated by an index key in a stored second index item, if both the first index item and the second index item are stored, there is a problem of storing two index items for same data.

In addition, if the difference between the two boundary values of the value range indicated by the index key in the first index item is greater than a second split threshold, or a difference between two boundary values of the value range indicated by the index key in the second index item is greater than a second split threshold, it indicates that the first index item or the second index item is corresponding to a relatively large amount of data.

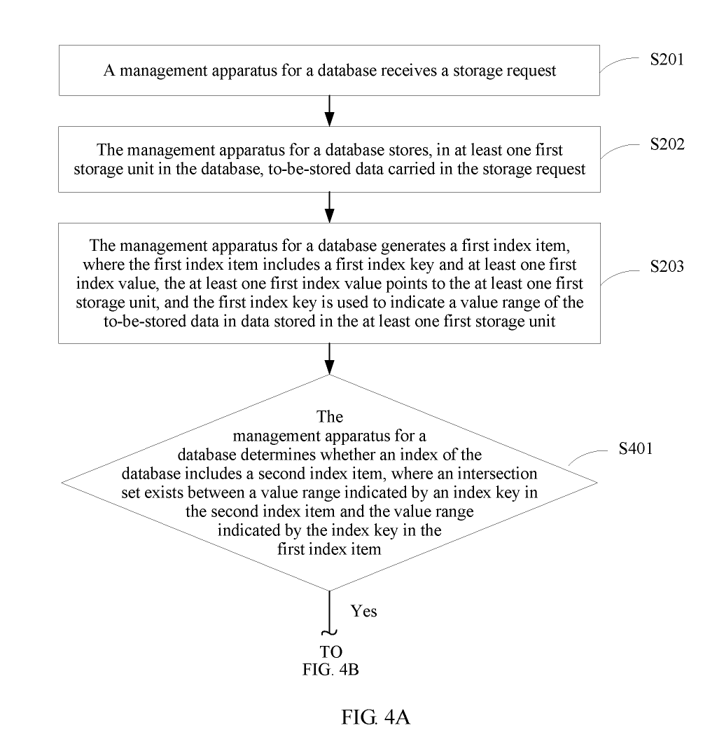

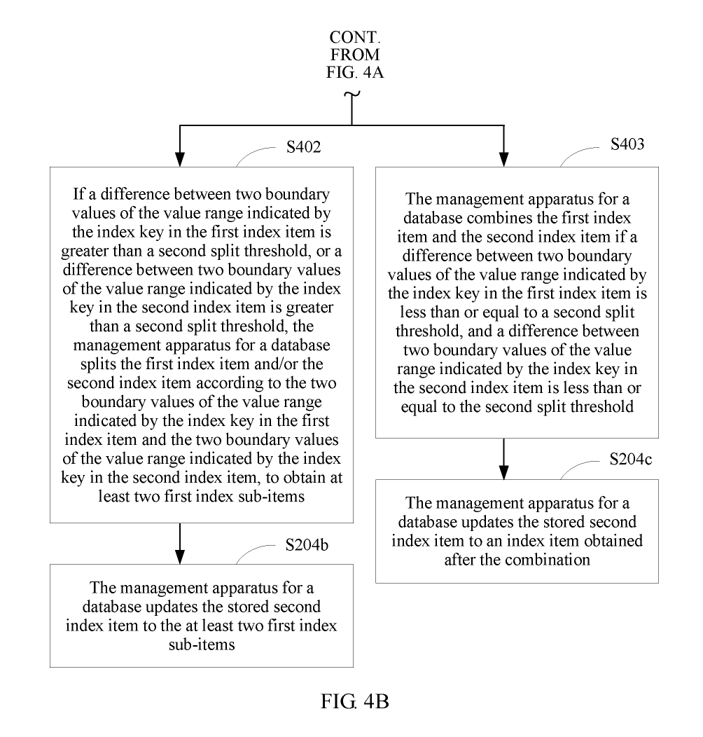

In this embodiment of the present invention, before storing the first index item in the index of the database, the management apparatus for a database may split the first index item and/or the second index item, to resolve the problem of storing two index items for same data and the problem that the first index item or the second index item is corresponding to a relatively large amount of data. Specifically, as shown in FIG. 4A, before S204 shown in FIG 2, the storage method for a database provided in this embodiment of the present invention may further include S401.

S401. The management apparatus for a database determines whether the index of the database includes a second index item, where an intersection set exists between a value range indicated by an index key in the second index item and the value range indicated by the index key in the first index item.

The management apparatus for a database may compare the value range indicated by the index key in the first index item with a value range indicated by an index key in each index item in the index of the database, to determine whether the index of the database includes a second index item, where an intersection set exists between a value range indicated by an index key in the second index item and the value range indicated by the index key in the first index item. The second index item includes the index key and at least one index value.

That an intersection set exists between a value range indicated by an index key in the second index item and the value range indicated by the index key in the first index item may be specifically as follows: A maximum boundary value of the value range indicated by the index key in the second index item is greater than or equal to a minimum boundary value of the value range indicated by the index key in the first index item, and a minimum boundary value of the value range indicated by the index key in the second index item is less than or equal to a maximum boundary value of the value range indicated by the index key in the first index item.

For example, it is assumed that the first index item may be {[min 1, max 1], {s4}}, the value range indicated by the index key in the first index item is [min 1, max 1], the second index item is {[min 2, max 2], {s5}}, and the value range indicated by the index key in the second index item is [min 2, max 2].

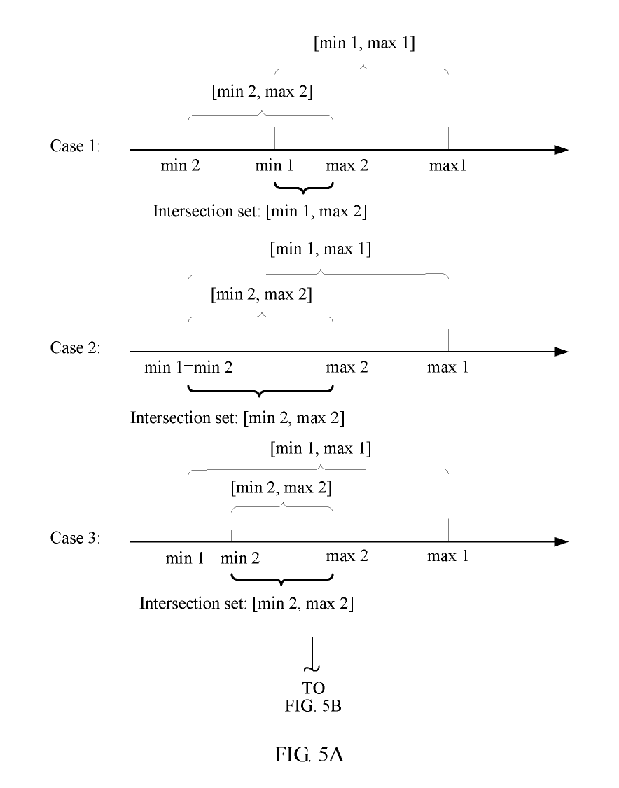

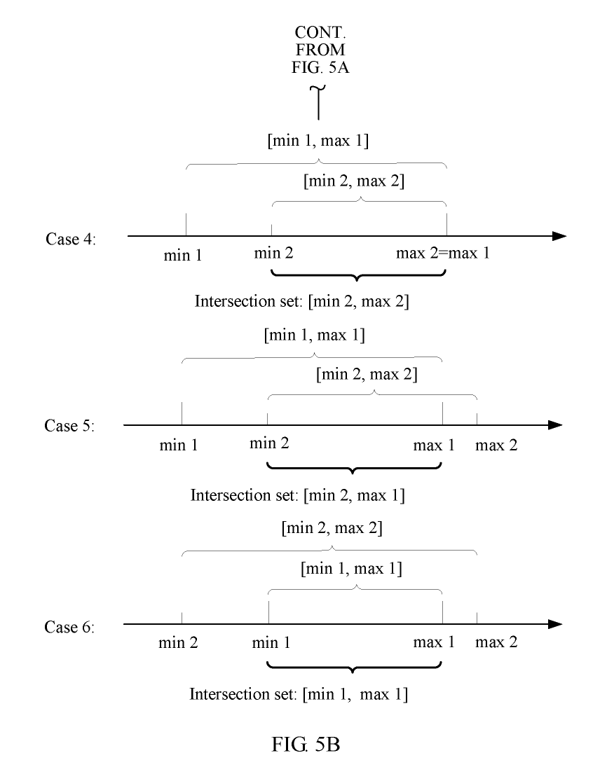

As shown in FIG. 5A and FIG. 5B, that an intersection set exists between a value range indicated by an index key in the second index item and the value range indicated by the index key in the first index item may specifically fall into the following six cases:

Case 1: min 2<min 1, min 1<max 2<max 1, and an intersection set between [min 1, max 1] and [min 2, max 2] is [min 1, max 2];

case 2: min 2=min 1, min 1<max 2<max 1, and an intersection set between [min 1, max 1] and [min 2, max 2] is [min 2, max 2];

case 3: min 2>min 1, max 2<max 1, and an intersection set between [min 1, max 1] and [min 2, max 2] is [min 2, max 2];

case 4: min 2>min 1, max 2=max 1, and an intersection set between [min 1, max 1] and [min 2, max 2] is [min 2, max 2];

case 5: min 1<min 2<max 1, max 2>max 1, and an intersection set between [min 1, max 1] and [min 2, max 2] is [min 2, max 1]; and

case 6: min 2<min 1, max 2>max 1, and an intersection set between [min 1, max 1] and [min 2, max 2] is [min 1, max 1].

Specifically, if the index of the database includes the second index item, the management apparatus for a database may continue to perform S402 or S403. If the index of the database does not include the second index item, the management apparatus for a database may continue to perform S301 and a subsequent procedure.

S402. If a difference between two boundary values of the value range indicated by the index key in the first index item is greater than a second split threshold, or a difference between two boundary values of the value range indicated by the index key in the second index item is greater than a second split threshold, the management apparatus for a database splits the first index item and/or the second index item according to the two boundary values of the value range indicated by the index key in the first index item and the two boundary values of the value range indicated by the index key in the second index item, to obtain at least two first index sub-items.

In an implementation of this embodiment of the present invention, the second split threshold may be a preset threshold.

In another implementation of this embodiment of the present invention, the management apparatus for a database may calculate a ratio of a difference between two boundary values of a current global value range to q, to obtain the second split threshold, where q is a total quantity of storage units to which all index values in the first index item point in the database.

In the another implementation, the second split threshold may be a difference between two boundary values of any one of q value ranges obtained after the current global value range is evenly divided. The current global value range includes value ranges indicated by index keys in all stored index items, and the value ranges indicated by the index keys in all the stored index items include the value range indicated by the index key in the first index item and the value range indicated by the index key in the second index item.

For example, as shown in FIG. 5A and FIG. 5B, the management apparatus for a database may split the first index item and/or the second index item into at least two first index sub-items according to min 1, max 1, min 2, and max 2. The first index item is {[min 1, max 1], {s4}}, and the second index item is {[min 2, max 2], {s5}}.

In Case 1 shown in FIG. 5A, the management apparatus for a database may use min 1 and max 2 as demarcation points to split the first index item and the second index item into three first index sub-items: {[min 2, min 1], {s5}}, {[min 1, max 2], {s5}}, and {[max 2, max 1], {s4}}.

In Case 2 shown in FIG. 5A, the management apparatus for a database may use max 2 as a demarcation point to split the first index item into two first index sub-items: {[min 2, max 2], {s5}} and {[max 2, max 1], {s4}}. In Case 2, min 2=min 1.

In Case 3 shown in FIG. 5A, the management apparatus for a database may use min 2 and max 2 as demarcation points to split the first index item into three first index sub-items: {[min 1, min 2], {s4}}, {[min 2, max 2], {s5}}, and {[max 2, max 1], {s4}}.

In Case 4 shown in FIG. 5B, the management apparatus for a database may use min 2 as a demarcation point to split the first index item into two first index sub-items: {[min 1, min 2], {s4}} and {[min 2, max 2], {s5}}. In Case 4, max 2=max 1.

In Case 5 shown in FIG. 5B, the management apparatus for a database may use min 2 and max 1 as demarcation points to split the first index item and the second index item into three first index sub-items: {[min 1, min 2], {s4}}, {[min 2, max 1], {s4}}, and {[max 1, max 2], {s5}}.

In Case 6 shown in FIG. 5B, the management apparatus for a database may use min 1 and max 1 as demarcation points to split the second index item into three first index sub-items: {[min 2, min 1], {s5}}, {[min 1, max 1], {s4}}, and {[max 1, max 2], {s5}}.

It should be noted that a value range indicated by an index key in any one of the at least two first index sub-items is less than or equal to the value range indicated by the index key in the first index item and/or the second index item that are/is split by the management apparatus for a database.

For example, Case 1 shown in FIG. 5A is used as an example. Because first index sub-items {[min 2, min 1], {s5}} and {[min 1, max 2], {s5}} are obtained after the management apparatus for a database splits the second index item, both a value range [min 2, min 1] indicated by an index key in {[min 2, min 1], {s5}} and a value range [min 1, max 2] indicated by an index key in {[min 1, max 2], {s5}} are less than the value range [min 2, max 2] indicated by the index key in the second index item. Because first index sub-items {[min 1, max 2], {s5}} and {[max 2, max 1], {s4}} are obtained after the management apparatus for a database splits the first index item, both the value range [min 1, max 2] indicated by the index key in {[min 1, max 2], {s5}} and a value range [max 2, max 1] indicated by an index key in {[max 2, max 1], {s4}} are less than the value range [min 1, max 1] indicated by the index key in the first index item.

A larger difference between two boundary values of a value range indicated by an index key in an index item indicates a larger amount of data corresponding to the index item. In this case, after the management apparatus for a database splits the first index item and/or the second index item into at least two first index sub-items, an amount of data corresponding to any one of the at least two first index sub-items is less than an amount of all data corresponding to the first index item and/or the second index item.

Correspondingly, after splitting the first index item and/or the second index item to obtain at least two first index sub-items, the management apparatus for a database may store the at least two first index sub-items. Specifically, as shown in FIG. 4B, S204 shown in FIG. 2 may be S204b.

S204b. The management apparatus for a database updates the stored second index item to the at least two first index sub-items.

The at least two first index sub-items are obtained after the first index item and the second index item are split or after the first index item is split or after the first index item is split. Therefore, data that is corresponding to the at least two first index sub-items and that is stored in storage units to which all index values in the at least two first index sub-items point includes all data that is corresponding to the first index item and the second index item and that is stored in all storage units to which all index values in the first index item and the second index item point. Therefore, the management apparatus for a database updates the stored second index item to the at least two first index sub-items, so that all data corresponding to the first index item and the second index item can be stored, and the problem of storing two index items for same data can also be resolved.

In addition, if the difference between the two boundary values of the value range indicated by the index key in the first index item is greater than the second split threshold, or the difference between the two boundary values of the value range indicated by the index key in the second index item is greater than the second split threshold, it indicates that the first index item or the second index item is corresponding to a relatively large amount of data. In this embodiment of the present invention, after the management apparatus for a database splits the first index item and/or the second index item into at least two first index sub-items, an amount of data corresponding to each first index sub-item is less than an amount of data corresponding to the first index item and/or the second index item. Therefore, an amount of data that needs to be read by the management apparatus for a database when reading the to-be-stored data from data that is stored in storage units to which all index values in any one of the at least two first index sub-items point and that is corresponding to the any one first index sub-item is less than an amount of data that needs to be read by the management apparatus for a database when reading the to-be-stored data from data that is corresponding to the first index item and/or the second index item and that is stored in storage units to which all index values in the first index item and/or the second index item point. That is, in this solution, an amount of data that needs to be read can be reduced, so that data query overheads can be reduced, and data query efficiency can be improved.

S403. The management apparatus for a database combines the first index item and the second index item if a difference between two boundary values of the value range indicated by the index key in the first index item is less than or equal to a second split threshold, and a difference between two boundary values of the value range indicated by the index key in the second index item is less than or equal to the second split threshold.

For example, as shown in FIG. 5A and FIG. 5B, it is assumed that the first index item is {[min 1, max 1], {s4}}, the value range indicated by the index key in the first index item is [min 1, max 1], the second index item is {[min 2, max 2], {s5}}, and the value range indicated by the index key in the second index item is [min 2, max 2]. The management apparatus for a database may combine the first index item and the second index item according to min 1, max 1, min 2, and max 2.

In Case 1 shown in FIG. 5A, the management apparatus for a database may use min 1 and max 2 as demarcation points to combine the first index item and the second index item whose value ranges have an intersection set. Index items obtained after the combination are respectively {[min 2, min 1], {s5}} and {[min 1, max 1], {s4, s5}}.

In Case 2 shown in FIG. 5A, the management apparatus for a database may use max 2 as a demarcation point to combine the first index item and the second index item whose value ranges have an intersection set. Index items obtained after the combination are respectively {[min 1, max 1], {s4}} and {[min 2, max 2], {s4, s5}}. In Case 2, min 2=min 1.

In Case 3 shown in FIG. 5A, the management apparatus for a database may use min 2 and max 2 as demarcation points to combine the first index item and the second index item whose value ranges have an intersection set. Index items obtained after the combination are respectively {[min 1, max 1], {s4}} and {[min 2, max 2], {s4, s5}}.

In Case 4 shown in FIG. 5B, the management apparatus for a database may use min 2 as a demarcation point to combine the first index item and the second index item whose value ranges have an intersection set. Index items obtained after the combination are respectively {[min 1, min 2], {s4}} and {[min 2, max 2], {s4, s5}}. In Case 4, max 2=max 1.

In Case 5 shown in FIG. 5B, the management apparatus for a database may use min 2 and max 1 as demarcation points to combine the first index item and the second index item whose value ranges have an intersection set. Index items obtained after the combination are respectively {[min 1, max 1], {s4, s5}} and {[max 1, max 2], {s5}}.

In Case 6 shown in FIG. 5B, the management apparatus for a database may use min 1 and max 1 as demarcation points to combine the first index item and the second index item whose value ranges have an intersection set. Index items obtained after the combination are respectively {[min 2, max 2], {s5}} and {[min 1, max 1], {s4, s5}}.

It should be noted that value ranges indicated by all index keys in the index items obtained after the combination are each less than or equal to value ranges indicated by all index keys in the first index item and the second index item.

For example, Case 1 shown in FIG. 5A is used as an example. Because the index items {[min 2, min 1], {s5}} and {[min 1, max 1], {s4, s5}} are obtained after the management apparatus for a database combines the first index item and the second index item, a value range [min 2, min 1] indicated by an index key in {[min 2, min 1], {s5}} is less than the value ranges indicated by all the index keys in the first index item and the second index item, and a value range [min 1, max 1] indicated by an index key in {[min 1, max 1], {s4, s5}} is less than the value ranges indicated by all the index keys in the first index item and the second index item.

A larger difference between two boundary values of a value range indicated by an index key in an index item indicates a larger amount of data corresponding to the index item. In this case, after the management apparatus for a database combines the first index item and the second index item, an amount of data corresponding to an index item obtained after the combination is less than an amount of all data corresponding to the first index item and the second index item.

Correspondingly, after combining the first index item and the second index item, the management apparatus for a database may store the index item obtained after the combination. Specifically, as shown in FIG. 4B, S204 shown in FIG. 2 may be S204c.

S204c. The management apparatus for a database updates the stored second index item to an index item obtained after the combination.

When the difference between the two boundary values of the value range indicated by the index key in the first index item is less than or equal to the second split threshold, and the difference between the two boundary values of the value range indicated by the index key in the second index item is less than or equal to the second split threshold, it indicates that the first index item or the second index item is corresponding to a relatively small amount of data.

When an intersection set exists between the value range indicated by the index key in the to-be-stored first index item and the value range indicated by the index key in the stored second index item, and the first index item and the second index item are each corresponding to a relatively small amount of data, it may be determined that the first index item and the second index item are substantially corresponding to same data. In this case, if the first index item is directly stored, because both the first index item and the second index item are stored, there is a problem of storing two index items for same data. In the foregoing solution, the first index item and the second index item may be combined, and the stored second index item may be updated to the index item obtained after the combination. In this way, the problem of storing two index items for same data can be resolved.

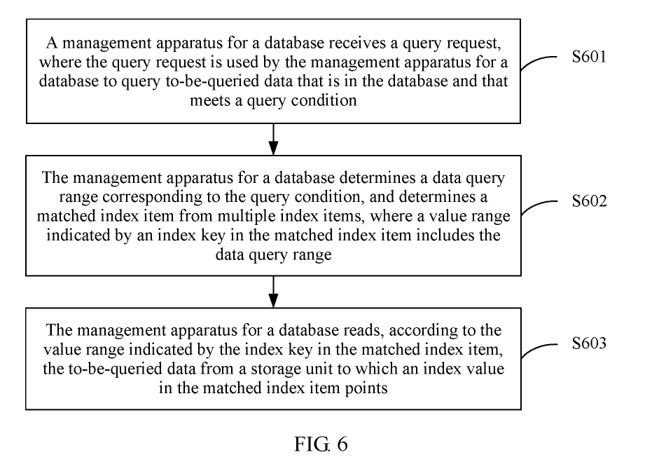

An embodiment of the present invention further provides a query method for a database. In the query method for a database, data in the database may be queried after data and an index item are stored by using the foregoing storage method for a database. As shown in FIG. 6, the query method for a database may include the following steps.

S601. A management apparatus for a database receives a query request, where the query request is used by the management apparatus for a database to query data that is in the database and that meets a query condition.

The query request may be a query statement for a database. The query statement for a database carries query information, and the query information includes a query object of the data and the query condition.

For example, the query statement for a database may be a Structured Query Language (SQL) statement. For example, the SQL statement may be: select c1, c2 from tab1 where c1=x and c1<y. Query information carried in the SQL statement includes query objects c1 and c2 of data and a query condition c1=x and c1<y. The data is the query objects c1 and c2 that meet the query condition c1=x and c1<y (that is, c1=x and c1<y).

Further, the query information may further include an identifier of a data block in which the data is located. For example, the SQL statement “select c1, c2 from tab 1 where c1=x and c1<y” may include an identifier tabl of a data block in which the data is located.

S602. The management apparatus for a database determines a data query range corresponding to the query condition, and determines a matched index item from multiple index items, where a value range indicated by an index key in the matched index item includes the data query range.

For example, when the query statement corresponding to the query information is “select c1, c2 from tab1 where c1>x and c1<y”, the query condition included in the query information is c1>x and c1<y, and the data query range that is corresponding to the query condition and that is determined by the management apparatus for a database may be [x, y]. When the query statement corresponding to the query information is “select c1, c2 from tab1 where c1=x”, the query condition included in the query information is c1=x, and the data query range corresponding to the query condition is [x−1, x] or [x, x+1].

An index key in each index item may be used to indicate a value range of data, that is, a value range of data in data stored in a storage unit to which at least one index value in the index item points, and the data query range is also a value range of data. Therefore, the management apparatus for a database may compare boundary values of the data query range with boundary values of the value range indicated by the index key in each index item in an index, to determine an index item (that is, the matched index item) whose index key indicates a value range that includes the data query range.

For example, that a value range indicated by an index key in the matched index item includes the data query range may be specifically as follows: A minimum boundary value of the value range indicated by the index key in the matched index item is less than or equal to a minimum boundary value of the data query range, and a maximum boundary value of the value range indicated by the index key in the matched index item is greater than or equal to a maximum boundary value of the data query range. A value range [a, b] is used as an example, a is a minimum boundary value of the value range [a, b], and b is a maximum boundary value of the value range [a, b].

For example, it is assumed that the value range indicated by the index key in the matched index item is [a, b], and the data query range is [x, y]. Two boundary values a and b of [a, b] and boundary values x and y of [x, y] should meet: a≤x and b≥y. It is assumed that the value range indicated by the index key in the matched index item is [a, b], and the data query range is [x−1, x]. Two boundary values a and b of [a, b] and boundary values x−1 and x of [x−1, x] should meet: a≤x−1 and b≥x. It is assumed that the value range indicated by the index key in the matched index item is [a, b], and the data query range is [x, x+1]. Two boundary values a and b of [a, b] and boundary values x and x+1 of [x, x+1] should meet: a≤x and b≥x+1.

S603. The management apparatus for a database reads, according to the value range indicated by the index key in the matched index item, the data from a storage unit to which an index value in the matched index item points.

In the query method for a database provided in this embodiment of the present invention, an index key in an index item is used to indicate a value range of data corresponding to the index item in first data (that is, data stored in a storage unit to which at least one index value points). Therefore, when reading the data, the management apparatus for a database in this embodiment of the present invention may read only data that is corresponding to the value range indicated by the index key in the matched index item and that is in data stored in the storage unit to which the index value in the matched index item points, and does not need to read, one by one, all the data stored in the storage unit indicated by the index item. In this way, a case in which a relatively large amount of redundant data (that is, data that is other than the data and that is stored in the storage unit to which the index value in the matched index item points) is read can be avoided, so that data query overheads can be reduced, and data query efficiency can be improved.

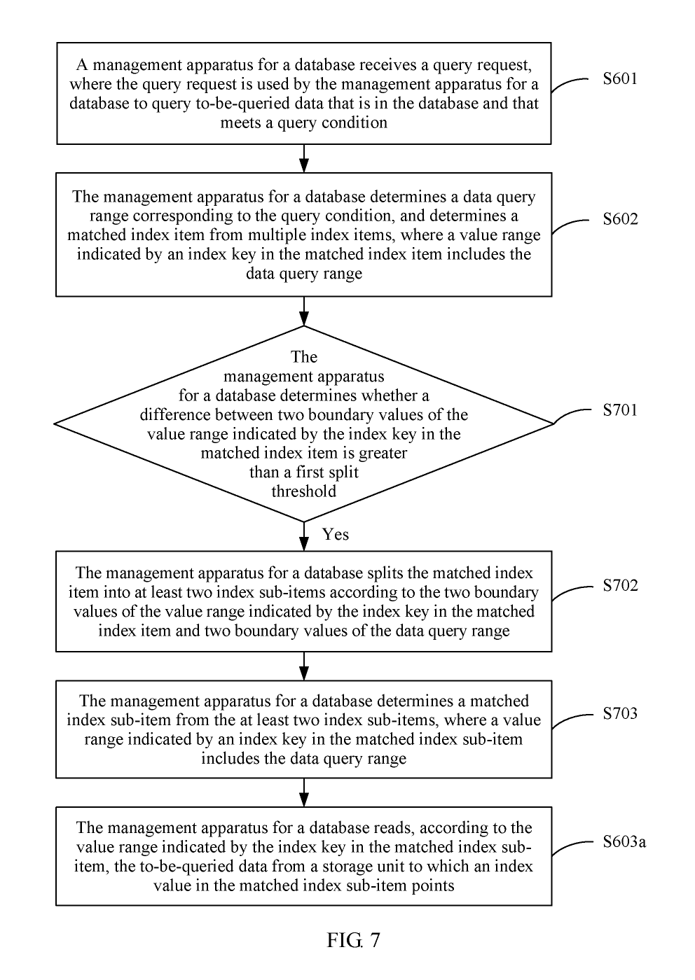

Further, because the value range indicated by the index key in the matched index item includes the data query range, the following case may exist: Because the value range indicated by the index key in the matched index item is far greater than the data query range, a relatively large amount of redundant data (that is, data that is other than the data, that is corresponding to the matched index item, and that is stored in storage units to which all index values in the matched index item point) needs to be read when the data is read from data that is corresponding to the matched index item and that is stored in the storage units to which all the index values in the matched index item point. Reading a relatively large amount of redundant data causes relatively high data query overheads, and affects data query efficiency. In this case, when a difference between two boundary values of the value range indicated by the index key in the matched index item is greater than a first split threshold, the management apparatus for a database may split the matched index item into at least two index sub-items. Specifically, as shown in FIG. 7, before S603 shown in FIG. 6, the method in this embodiment of the present invention may further include S701 to S703.

S701. The management apparatus for a database determines whether a difference between two boundary values of the value range indicated by the index key in the matched index item is greater than a first split threshold.

Specifically, if the difference between the two boundary values of the value range indicated by the index key in the matched index item is greater than the first split threshold, it indicates that the matched index item is corresponding to a relatively large amount of data, and the management apparatus for a database may continue to perform S702. If the difference between the two boundary values of the value range indicated by the index key in the matched index item is less than or equal to the first split threshold, it indicates that the matched index item is corresponding to a relatively small amount of data, and the management apparatus for a database may continue to perform S603.

S702. The management apparatus for a database splits the matched index item into at least two index sub-items according to the two boundary values of the value range indicated by the index key in the matched index item and two boundary values of the data query range.

In an implementation of this embodiment of the present invention, the first split threshold may be a preset threshold.

In another implementation of this embodiment of the present invention, the management apparatus for a database may calculate a ratio of a difference between two boundary values of a current global value range to m, to obtain the first split threshold, where m is a total quantity of storage units to which all the index values in the matched index item point.

That is, in the another implementation, the first split threshold is a difference between two boundary values of any one of m value ranges obtained after the current global value range is evenly divided. The current global value range includes value ranges indicated by index keys in all stored index items, and the value ranges indicated by the index keys in all the stored index items include the value range indicated by the index key in the matched index item.

For example, it is assumed that two index items are currently stored: an index item 1 and an index item 2, the index item 1 is the matched index item, a value range indicated by an index key in the index item 1 is [5, 7], and a value range indicated by an index key in the index item 2 is [8, 9]. The management apparatus for a database may determine that the current global value range is [5, 9]. The current global value range [5, 9] includes the value ranges [5, 7] and [8, 9] that are indicated by the index keys in all the stored index items.

It should be noted that the current global value range in this embodiment of the present invention may be specifically a minimum value range that includes the value ranges indicated by the index keys in all the stored index items.

For example, because the value range indicated by the index key in the matched index item includes the data query range, the management apparatus for a database may use the two boundary values of the data query range as demarcation points to split the matched index item into at least two index sub-items.

For example, it is assumed that the matched index item is {[a, b], {s2, s3}}, the data query range is [x, y], and a<x<y<b. The management apparatus for a database may use x and/or y as demarcation points or a demarcation point to split the matched index item into at least two index sub-items.

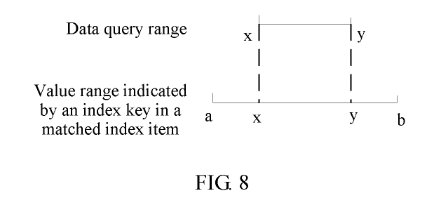

Specifically, as shown in FIG. 8, when a<x<y<b, the management apparatus for a database may use x and y as demarcation points to split the matched index item into three index sub-items. The three index sub-items are respectively {[a, x], {s2, s3}}, {[x, y], {s2, s3}}, and {[y, b], {s2, s3}}.

When a=x and x<y<b, the management apparatus for a database may use y as a demarcation point to split the matched index item into two index sub-items. The two index sub-items are respectively {[a, y], {s2, s3}} and {[y, b], {s2, s3}}.

When a<x<y and y=b, the management apparatus for a database may use x as a demarcation point to split the matched index item into two index sub-items. The two index sub-items are respectively {[a, x], {s2, s3} and {[x, y], {s2, s3}}.

The value range indicated by the index key in the matched index item includes the data query range, that is, the value range indicated by the index key in the matched index item is greater than or equal to the data query range, and the at least two index sub-items are obtained after the matched index item is split according to the two boundary values of the value range indicated by the index key in the matched index item and the two boundary values of the data query range. Therefore, a value range indicated by an index key in one (that is, a matched index sub-item) of the at least two index sub-items may include the data query range, that is, the value range indicated by the index key in the matched index sub-item is greater than or equal to the data query range.

For example, the case of a<x<y<b that is shown in FIG. 8 is used as an example. A value range [x, y] indicated by an index key in the index sub-item {[x, y], {s2, s3}} in the three index sub-items {[a, x], {s2, s3}}, {[x, y], {s2, s3}}, and {[y, b], {s2, s3}} that are obtained by the management apparatus for a database after the splitting includes the data query range [x, y].

A larger difference between two boundary values of a value range indicated by an index key in an index item indicates a larger amount of data corresponding to the index item. In this case, after the management apparatus for a database splits the matched index item into at least two index sub-items, an amount of data corresponding to any one of the at least two index sub-items is less than an amount of data corresponding to the matched index item.

For example, the case of a<x<y<b that is shown in FIG. 8 is used as an example. Because value ranges [a, x], [x, y], and [y, b] that are indicated by index keys in the three index sub-items {[a, x], {s2, s3}}, {[x, y], {s2, s3}}, and {[y, b], {s2, s3}}are all less than [a, b], an amount of data corresponding to each of the three index sub-items is less than an amount of data corresponding to {[a, b], {s2, s3}}.

S703. The management apparatus for a database determines a matched index sub-item from the at least two index sub-items, where a value range indicated by an index key in the matched index sub-item includes the data query range.

The management apparatus for a database may determine, as the matched index sub-item, an index sub-item that is in the at least two index sub-items and whose index key indicates a value range that includes the data query range.

For example, the case of a<x<y<b that is shown in FIG. 8 is used as an example. Because the value range [x, y] indicated by the index key in the index sub-item {[x, y], {s2, s3 }} includes the data query range [x, y], the management apparatus for a database may determine the index sub-item {[x, y], {s2, s3 }} as the matched index sub-item.

After determining the matched index sub-item, the management apparatus for a database may read the data from a storage unit to which an index value in the matched index sub-item points. Specifically, as shown in FIG. 7, S603 shown in FIG. 6 may be replaced with S603a.

S603a. The management apparatus for a database reads, according to the value range indicated by the index key in the matched index sub-item, the data from a storage unit to which an index value in the matched index sub-item points.

The amount of data corresponding to any one (such as the matched index sub-item) of the at least two index sub-items is less than the amount of data corresponding to the matched index item, and both the value range indicated by the index key in the matched index sub-item and the value range indicated by the index key in the matched index item include the data query range. Therefore, it may be determined that an amount of redundant data (that is, data that is other than the data, that is corresponding to the matched index sub-item, and that is stored in storage units to which all index values in the matched index sub-item point) stored in the storage units to which all the index values in the matched index sub-item point is less than an amount of redundant data (that is, data that is other than the data, that is corresponding to the matched index item, and that is stored in the storage units to which all the index values in the matched index item point) stored in the storage units to which all the index values in the matched index item point. The management apparatus for a database reads the data from data that is corresponding to the matched index sub-item and that is stored in the storage units to which all the index values in the matched index sub-item point, so that an amount of redundant data that needs to be read can be further reduced, data query overheads can be further reduced, and data query efficiency can be further improved.

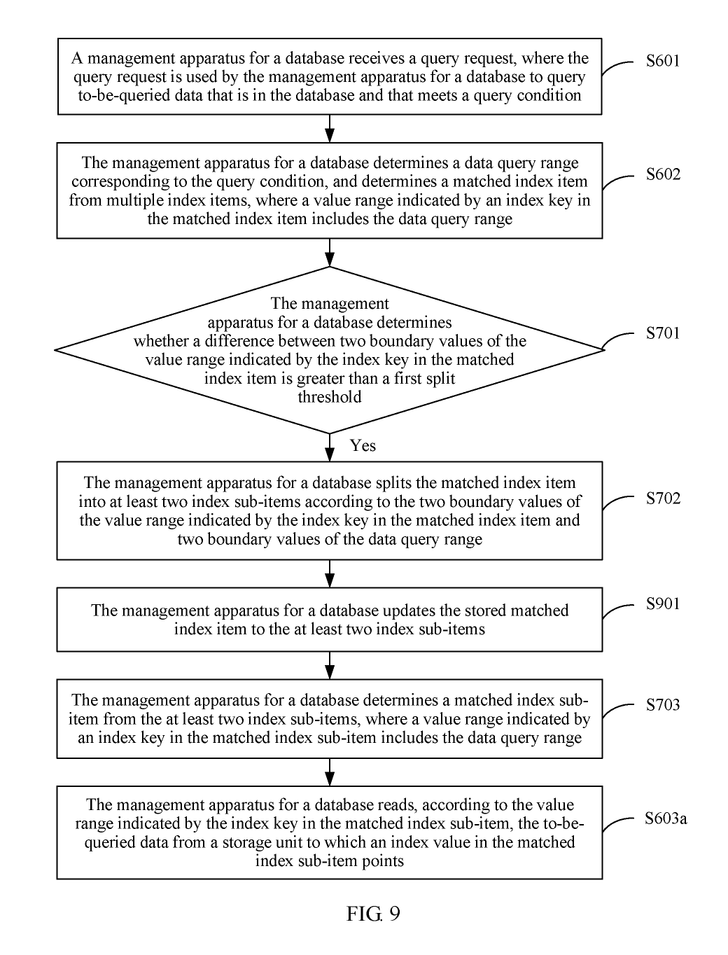

Further, after the management apparatus for a database splits the matched index item into at least two index sub-items, the management apparatus for a database may further store the at least two index sub-items. Specifically, as shown in FIG. 9, before S702 shown in FIG. 7, the method in this embodiment of the present invention may further include S901.

S901. The management apparatus for a database updates the stored matched index item to the at least two index sub-items.

A larger difference between two boundary values of a value range indicated by an index key in an index item indicates a larger amount of data corresponding to the index item. In this case, after the matched index item is split into at least two index sub-items, an amount of data corresponding to any one of the at least two index sub-items is less than the amount of data corresponding to the matched index item.

The foregoing mainly describes the solutions provided in the embodiments of the present invention from a perspective of the management apparatus for a database. It can be understood that, to implement the foregoing functions, the management apparatus for a database includes a corresponding hardware structure and/or software module for implementing each function. A person skilled in the art should be easily aware that, the management apparatus for a database and algorithm steps in each example described with reference to the embodiments disclosed in this specification can be implemented in a form of hardware or a combination of hardware and computer software in the present invention. Whether a function is implemented by hardware or computer software driving hardware depends on particular applications and design constraint conditions of the technical solutions. A person skilled in the art may use different methods to implement the described functions for each particular application, but it should not be considered that the implementation goes beyond the scope of the present invention.

In the embodiments of the present invention, the management apparatus for a database may be divided into function modules or function units according to the foregoing method examples. For example, each function module or function unit may be obtained by means of division according to a corresponding function, or two or more functions may be integrated into one processing module. The integrated module may be implemented in a form of hardware, or may be implemented in a form of a software function module or function unit. The module or unit division in the embodiments of the present invention is an example, is only logical function division, and may be other division in actual implementation.

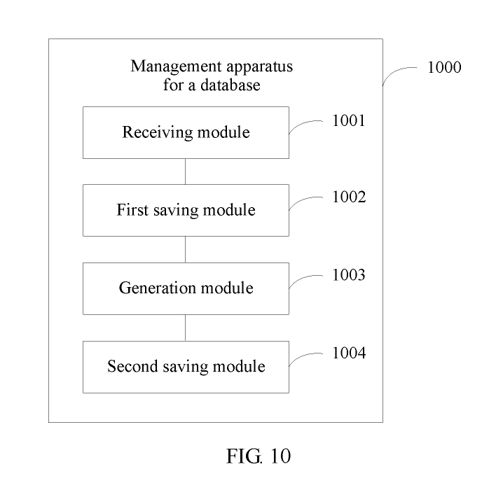

FIG. 10 is a possible schematic structural diagram of the management apparatus for a database in the foregoing embodiments. A management apparatus 1000 for a database may include a receiving module 1001, a first saving module 1002, a generation module 1003, and a second saving module 1004.

The receiving module 1001 is configured to support S201 in the foregoing embodiment, and/or is configured to execute another process of the technology described in this specification. The first saving module 1002 is configured to support S202 in the foregoing embodiment, and/or is configured to execute another process of the technology described in this specification. The generation module 1003 is configured to support S203 in the foregoing embodiment, and/or is configured to execute another process of the technology described in this specification. The second saving module 1004 is configured to support S204, S204a, S204b, and S204c in the foregoing embodiment, and/or is configured to execute another process of the technology described in this specification.

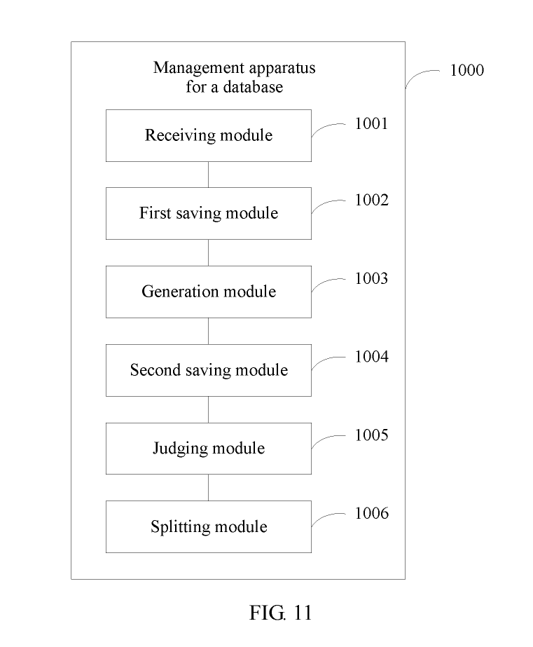

Further, in a first application scenario of this embodiment of the present invention, as shown in FIG. 11, the management apparatus 1000 for a database shown in FIG. 10 may further include a determining module 1005 and a splitting module 1006. The judging module 1005 is configured to support S301 in the foregoing embodiment, and/or is configured to execute another process of the technology described in this specification. The splitting module 1006 is configured to support S302 in the foregoing embodiment, and/or is configured to execute another process of the technology described in this specification.

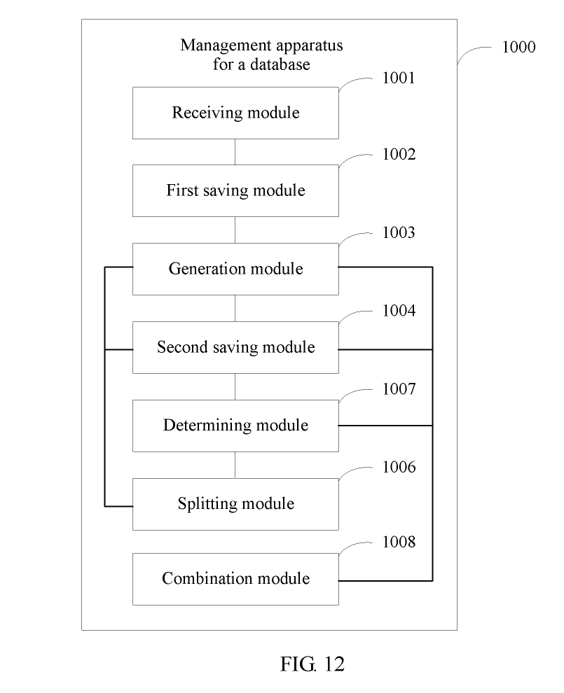

Further, in a second application scenario of this embodiment of the present invention, as shown in FIG. 12, the management apparatus 1000 for a database shown in FIG. 10 may further include a splitting module 1006, a determining module 1007, and a combination module 1008. The determining module 1007 is configured to support S401 in the foregoing embodiment, and/or is configured to execute another process of the technology described in this specification. The splitting module 1006 is configured to support S402 in the foregoing embodiment, and/or is configured to execute another process of the technology described in this specification. The combination module 1008 is configured to support S403 in the foregoing embodiment, and/or is configured to execute another process of the technology described in this specification.

The management apparatus 1000 for a database may further include a calculation module. The determining module 1007 may be further configured to determine a current global value range. The calculation module is configured to: calculate a ratio of two boundary values of the current global value range to q, to obtain a second split threshold; and calculate a ratio of the two boundary values of the current global value range to n, to obtain a third split threshold.

Certainly, the management apparatus 1000 for a database provided in this embodiment of the present invention includes but is not limited to the foregoing modules. For example, the management apparatus 1000 for a database may further include a sending module and a storage module. The storage module may be configured to store an index in this embodiment of the present invention. The sending module may be configured to send data that is queried.

When an integrated unit is used, the first saving module 1002, the generation module 1003, the second saving module 1004, the calculation module, the determining module 1007, the splitting module 1006, the combination module 1008, the judging module 1005, and the like may be integrated into one processing module for implementation. The processing module may be a processor or a controller. For example, the processing module may be a CPU, a general-purpose processor, a Digital Signal Processor (DSP), an Application-Specific Integrated Circuit (ASIC), a Field Programmable Gate Array (FPGA) or another programmable logic device, a transistor logic device, a hardware component, or any combination thereof. The processing module may implement or execute various example logical blocks, modules, and circuits described with reference to content disclosed in the present invention. Alternatively, the processing unit may be a combination that implements a computation function, for example, a combination that includes one or more microprocessors, or a combination of a DSP and a microprocessor. The sending module and the receiving module 1001 may be integrated into one communications module for implementation. The communications module may be a communications interface. The storage module may be a memory.

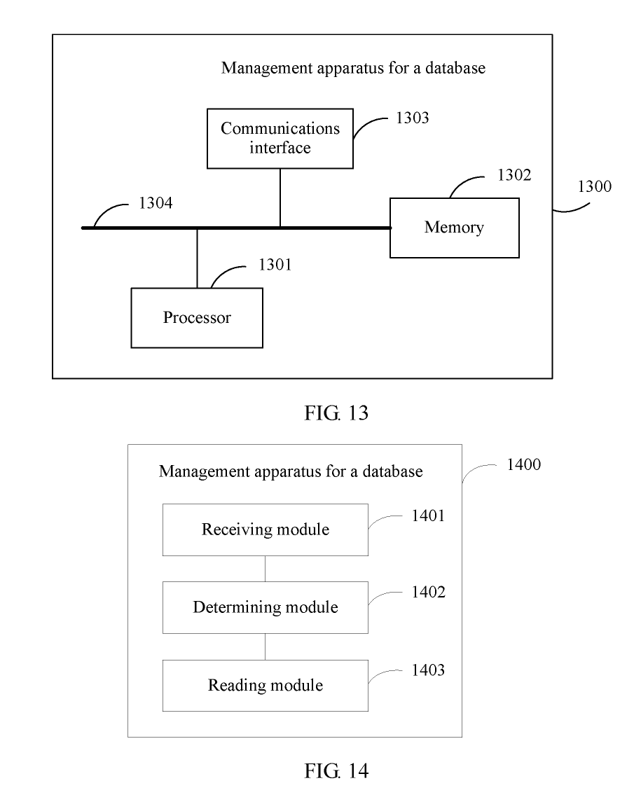

When the processing module is a processor, the storage module is a memory, and the commutations module is a transceiver, the management apparatus 1000 for a database in this embodiment of the present invention may be a management apparatus 1300 for a database shown in FIG. 13. As shown in FIG. 13, the management apparatus 1300 for a database includes a processor 1301, a memory 1302, and a communications interface 1303. The processor 1301, the memory 1302, and the communications interface 1303 are connected to each other by using a bus 1304.

The bus 1304 may be a peripheral component interconnect (English: Peripheral Component Interconnect, PCI for short) bus, an extended industry standard architecture (English: Extended Industry Standard Architecture, EISA for short) bus, or the like. The bus 1304 may fall into an address bus, a data bus, a control bus, or the like. For ease of denotation, the bus is indicated by using only one thick line in FIG. 13, but it does not indicate that there is only one bus or only one type of bus.

The management apparatus 1300 for a database may include one or more processors 1301, that is, the management apparatus 1300 for a database may include a multi-core processor.

An embodiment of the present invention further provides a computer storage medium, and the computer storage medium stores code. When the processor 1301 in the management apparatus 1300 for a database executes the program codes, the management apparatus 1300 for a database performs the related method steps in any one of FIG. 2 to FIG. 4A and FIG. 4B.

For detailed descriptions of the modules in the management apparatus 1300 for a database provided in this embodiment of the present invention and technical effects brought after the modules or units perform the related method steps in any one of FIG. 2 to FIG. 4A and FIG. 4B, refer to the related descriptions in the method embodiment of the present invention. Details are not described herein.

An embodiment of the present invention further provides a management apparatus 1400 for a database. The database includes multiple storage units. An index of the database includes multiple index items. Each index item includes an index key and at least one index value. Each of the at least one index value points to one storage unit in the database. The index key is used to indicate a value range of data corresponding to the index item in first data. The first data is data stored in a storage unit to which the at least one index value points. FIG. 14 is a possible schematic structural diagram of the management apparatus for a database in the foregoing embodiments. The management apparatus 1400 for a database includes a receiving module 1401, a determining module 1402, and a reading module 1403.

The receiving module 1401 is configured to support S601 in the foregoing embodiment, and/or is configured to execute another process of the technology described in this specification. The determining module 1402 is configured to support S602 and S703 in the foregoing embodiment, and/or is configured to execute another process of the technology described in this specification. The reading module 1403 is configured to support S603 and S603a in the foregoing embodiment, and/or is configured to execute another process of the technology described in this specification.

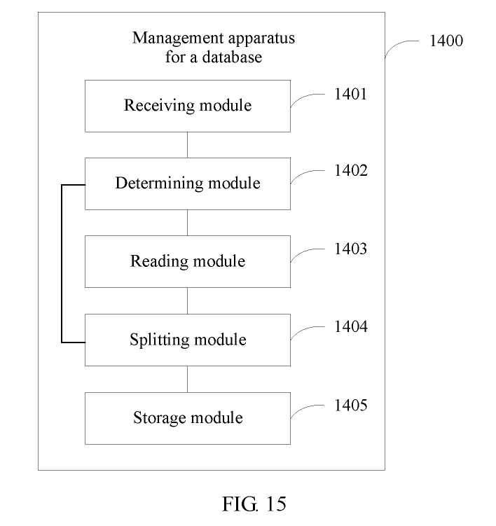

Further, as shown in FIG. 15, the management apparatus 1400 for a database that is shown in FIG. 14 may further include a splitting module 1404 and a storage module 1405. The splitting module 1404 is configured to support S701 and S702 in the foregoing embodiment, and/or is configured to execute another process of the technology described in this specification. The storage module 1405 is configured to support S901 in the foregoing embodiment, and/or is configured to execute another process of the technology described in this specification.

The management apparatus 1400 for a database may further include a calculation module. The determining module 1402 may be further configured to determine a current global value range. The calculation module is configured to calculate a ratio of a difference between two boundary values of the current global value range to m, to obtain a first split threshold.

Certainly, the management apparatus 1400 for a database provided in this embodiment of the present invention includes but is not limited to the foregoing modules. For example, the management apparatus 1400 for a database may further include a sending module. The sending module may be configured to send data that is queried.

When an integrated unit is used, the determining module 1402, the reading module 1403, the splitting module 1404, and the like may be integrated into one processing module for implementation. The processing module may be a processor or a controller. For example, the processing module may be a CPU, a general-purpose processor, a DSP, an ASIC, an FPGA or another programmable logic device, a transistor logic device, a hardware component, or any combination thereof. The processing module may implement or execute various example logical blocks, modules, and circuits described with reference to content disclosed in the present invention. Alternatively, the processing unit may be a combination that implements a computation function, for example, a combination that includes one or more microprocessors, or a combination of a DSP and a microprocessor. The sending module and the receiving module 1401 may be integrated into one communications module for implementation. The communications module may be a communications interface. The storage module 1405 may be a memory.

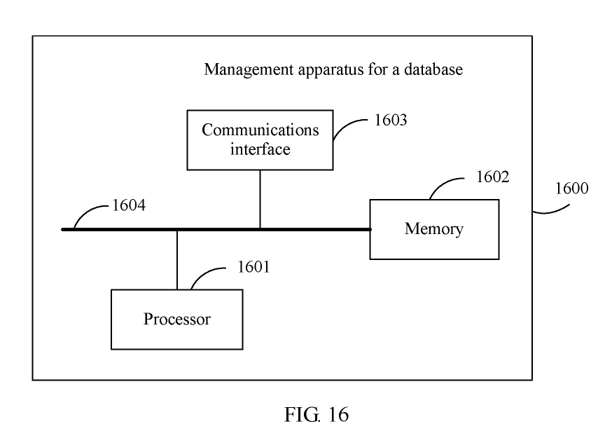

When the processing module is a processor, the storage module is a memory, and the commutations module is a transceiver, the management apparatus 1400 for a database in this embodiment of the present invention may be a management apparatus 1600 for a database shown in FIG. 16. As shown in FIG. 16, the management apparatus 1600 for a database includes a processor 1601, a memory 1602, and a communications interface 1603. The processor 1601, the memory 1602, and the communications interface 1603 are connected to each other by using a bus 1604.

The bus 1604 may be a PCI bus, an EISA bus, or the like. The bus 1604 may fall into an address bus, a data bus, a control bus, or the like. For ease of denotation, the bus is indicated by using only one thick line in FIG. 16, but it does not indicate that there is only one bus or only one type of bus.

The management apparatus 1600 for a database may include one or more processors 1601, that is, the management apparatus 1600 for a database may include a multi-core processor.

An embodiment of the present invention further provides a computer storage medium, and the computer storage medium stores code. When the processor 1601 in the management apparatus 1600 for a database executes the program codes, the management apparatus 1600 for a database performs the related method steps in any one of FIG. 6, FIG. 7, or FIG. 9.

For detailed descriptions of the modules in the management apparatus 1600 for a database provided in this embodiment of the present invention and technical effects brought after the modules or units perform the related method steps in any one of FIG. 6, FIG. 7, or FIG. 9, refer to the related descriptions in the method embodiment of the present invention. Details are not described herein.

Based on the description of the foregoing implementations, a person skilled in the art may clearly understand that, for the purpose of convenient and brief description, division of the function modules is used as an example for illustration. In actual application, the foregoing functions can be allocated to different modules for implementation according to a requirement, that is, an inner structure of an apparatus is divided into different function modules to implement all or some of the functions described above. For a detailed working process of the foregoing system, apparatus, and unit, refer to a corresponding process in the foregoing method embodiments. Details are not described herein.

In the several embodiments provided in this application, it should be understood that the disclosed system, apparatus, and method may be implemented in other manners. For example, the described apparatus embodiments are only examples. For example, the module or unit division is only logical function division and may be another division in an actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to an actual requirement to achieve the objectives of the solutions in the embodiments.

In addition, the function units in the embodiments of the present invention may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software function unit and sold or used as an independent product, the integrated unit may be stored in a computer-readable storage medium. Based on such an understanding, the technical solutions in the present invention essentially, or the part contributing to the prior art, or all or some of the technical solutions may be implemented in a form of a software product. The computer software product is stored in a storage medium and includes several instructions for instructing a computer device (which may be a personal computer, a server, a network device, or the like) or a processor to perform all or some of the steps of the methods described in the embodiments of the present invention. The foregoing storage medium includes any medium that can store program code, such as a USB flash drive, a removable hard disk, a Read-Only Memory (ROM), a Random Access Memory (RAM), a magnetic disk, or an optical disc.

The foregoing descriptions are only specific implementations of the present invention, but are not intended to limit the protection scope of the present invention. Any variation or replacement within the technical scope disclosed in the present invention shall fall within the protection scope of the present invention. Therefore, the protection scope of the present invention shall be subject to the protection scope of the claims.

What is claimed is:

1. A query method for a database, the method comprises:
receiving a query request, wherein an index of the database comprises multiple index items, each index item comprises an index key and at least one index value, each of the at least one index value points to a storage unit in the database, the index key is used to indicate a value range of data corresponding to the index item in first data, the first data is data stored in a storage unit to which the at least one index value points,;
determining a data query range corresponding to the query condition, and determining a matched index item from the multiple index items, wherein a value range indicated by an index key in the matched index item comprises the data query range; and
reading, according to the value range indicated by the index key in the matched index item, the data.

2. The method according to claim 1, the method further comprises:
when a difference between two boundary values of the value range indicated by the index key in the matched index item is greater than a first split threshold, splitting the matched index item into at least two index sub-items according to the two boundary values of the value range indicated by the index key in the matched index item and two boundary values of the data query range; and
determining a matched index sub-item from the at least two index sub-items, wherein a value range indicated by an index key in the matched index sub-item comprises the data query range.

3. The method according to claim 1, wherein the database comprises multiple storage units, the method further comprises:
receiving a storage request, and storing, in at least one first storage unit in the database, data carried in the storage request;
generating a first index item, wherein the first index item comprises a first index key and at least one first index value, the at least one first index value points to the at least one first storage unit, and the first index key is used to indicate a value range of the data in the at least one first storage unit.

4. The method according to claim 3, the method further comprises:
determining a second index item from the index of the database, wherein there is an intersection set between a value range indicated by an index key in the second index item and the value range indicated by the index key in the first index item; and
when a difference between two boundary values of the value range indicated by the index key in the first index item is greater than a second split threshold, splitting the first index item according to the two boundary values of the value range indicated by the index key in the first index item, to obtain at least two first index sub-items.

5. The method according to claim 3, the method further comprises:
determining a second index item from the index of the database, wherein there is an intersection set between a value range indicated by an index key in the second index item and the value range indicated by the index key in the first index item; and
when a difference between two boundary values of the value range indicated by the index key in the second index item is greater than a second split threshold, splitting the second index item according to the two boundary values of the value range indicated by the index key in the second index item, to obtain at least two first index sub-items.

6. The method according to claim 4, wherein the method further comprises:
combining the first index item and the second index item when the difference between the two boundary values of the value range indicated by the index key in the first index item is less than or equal to the second split threshold, and the difference between the two boundary values of the value range indicated by the index key in the second index item is less than or equal to the second split threshold.

7. The method according to claim 3, the method further comprises:
splitting the first index item into k index sub-items when a difference between two boundary values of the value range indicated by the index key in the first index item is greater than a third split threshold.

8. A management apparatus, wherein the management apparatus comprises a processor, a memory, and a communications interface; and the processor, the communications interface, and the memory are connected by using a bus; and the memory is configured to store a plurality of instructions that, when executed, causes the processor to perform the method which comprises:
receiving a query request, wherein an index of a database comprises multiple index items, each index item comprises an index key and at least one index value, each of the at least one index value points to a storage unit in the database, the index key is used to indicate a value range of data corresponding to the index item in first data, the first data is data stored in a storage unit to which the at least one index value points,;
determining a data query range corresponding to the query condition, and determining a matched index item from the multiple index items, wherein a value range indicated by an index key in the matched index item comprises the data query range; and
reading, according to the value range indicated by the index key in the matched index item, the data.

9. The apparatus according to claim 8, the method further comprises:
when a difference between two boundary values of the value range indicated by the index key in the matched index item is greater than a first split threshold, splitting the matched index item into at least two index sub-items according to the two boundary values of the value range indicated by the index key in the matched index item and two boundary values of the data query range; and
determining a matched index sub-item from the at least two index sub-items, wherein a value range indicated by an index key in the matched index sub-item comprises the data query range.

10. The apparatus according to claim 8, wherein the database comprises multiple storage units, the method further comprises:
receiving a storage request, and storing, in at least one first storage unit in the database, data carried in the storage request;
generating a first index item, wherein the first index item comprises a first index key and at least one first index value, the at least one first index value points to the at least one first storage unit, and the first index key is used to indicate a value range of the data in the at least one first storage unit.

11. The apparatus according to claim 10, the method further comprises:
determining a second index item from the index of the database, wherein there is an intersection set between a value range indicated by an index key in the second index item and the value range indicated by the index key in the first index item; and
when a difference between two boundary values of the value range indicated by the index key in the first index item is greater than a second split threshold, splitting the first index item according to the two boundary values of the value range indicated by the index key in the first index item, to obtain at least two first index sub-items.

12. The apparatus according to claim 10, the method further comprises:
determining a second index item from the index of the database, wherein there is an intersection set between a value range indicated by an index key in the second index item and the value range indicated by the index key in the first index item; and
when a difference between two boundary values of the value range indicated by the index key in the second index item is greater than a second split threshold, splitting the second index item according to the two boundary values of the value range indicated by the index key in the second index item, to obtain at least two first index sub-items.

13. The apparatus according to claim 10, wherein the method further comprises:
combining the first index item and the second index item when the difference between the two boundary values of the value range indicated by the index key in the first index item is less than or equal to the second split threshold, and the difference between the two boundary values of the value range indicated by the index key in the second index item is less than or equal to the second split threshold.

14. The apparatus according to claim 10, the method further comprises:
splitting the first index item into k index sub-items when a difference between two boundary values of the value range indicated by the index key in the first index item is greater than a third split threshold.

15. A non-transitory computer-readable medium storing computer instructions for data processing, that when executed by one or more processors, cause the one or more processors to perform the method, which comprises:
receiving a query request, wherein an index of the database comprises multiple index items, each index item comprises an index key and at least one index value, each of the at least one index value points to a storage unit in the database, the index key is used to indicate a value range of data corresponding to the index item in first data, the first data is data stored in a storage unit to which the at least one index value points,;
determining a data query range corresponding to the query condition, and determining a matched index item from the multiple index items, wherein a value range indicated by an index key in the matched index item comprises the data query range; and
reading, according to the value range indicated by the index key in the matched index item, the data.

16. The medium according to claim 15, the method further comprises:
when a difference between two boundary values of the value range indicated by the index key in the matched index item is greater than a first split threshold, splitting the matched index item into at least two index sub-items according to the two boundary values of the value range indicated by the index key in the matched index item and two boundary values of the data query range; and
determining a matched index sub-item from the at least two index sub-items, wherein a value range indicated by an index key in the matched index sub-item comprises the data query range.

17. The medium according to claim 15, wherein the database comprises multiple storage units, the method further comprises:
receiving a storage request, and storing, in at least one first storage unit in the database, data carried in the storage request;
generating a first index item, wherein the first index item comprises a first index key and at least one first index value, the at least one first index value points to the at least one first storage unit, and the first index key is used to indicate a value range of the data in the at least one first storage unit.

18. The medium according to claim 17, the method further comprises:
determining a second index item from the index of the database, wherein there is an intersection set between a value range indicated by an index key in the second index item and the value range indicated by the index key in the first index item; and
when a difference between two boundary values of the value range indicated by the index key in the first index item is greater than a second split threshold, splitting the first index item according to the two boundary values of the value range indicated by the index key in the first index item, to obtain at least two first index sub-items.

19. The medium according to claim 17, the method further comprises:
determining a second index item from the index of the database, wherein there is an intersection set between a value range indicated by an index key in the second index item and the value range indicated by the index key in the first index item; and
when a difference between two boundary values of the value range indicated by the index key in the second index item is greater than a second split threshold, splitting the second index item according to the two boundary values of the value range indicated by the index key in the second index item, to obtain at least two first index sub-items.

20. The medium according to claim 17, the method further comprises:
splitting the first index item into k index sub-items when a difference between two boundary values of the value range indicated by the index key in the first index item is greater than a third split threshold.
